(19) United States
(12) Patent Application Publication
(10) Pub. No.: US 2012/0293473 A1
(43) Pub. Date: Nov. 22, 2012

(54) DISPLAY APPARATUS AND IMAGE COMPENSATING METHOD THEREOF

(75) Inventors: Tzung-Yuan Lee, Taichung City (TW); Ching-Chuan Hsu, Taichung City (TW); Chun-Yi Chou, Hsinchu City (TW)

(73) Assignee: NOVATEK MICROELECTRONICS CORP., Hsinchu (TW)

(21) Appl. No.: 13/169,063

(22) Filed: Jun. 27, 2011

(30) Foreign Application Priority Data
May 16, 2011 (TW) 100117045

(51) Int. Cl. G09G 5/00

(52) U.S. Cl. 345/207

(57) ABSTRACT

A display apparatus is disclosed. The display apparatus includes an environment luminance detector, a display image data analyser, and an image compensation processor. The environment luminance detector detects an environment luminance and generates an environment luminance grade according to the environment luminance. The display image data analyser receives display image data and analyses a luminance of the display image data to generate a display image data luminance grade. The image compensation processor generates an image luminance enhancement value, an image color compensating value and an image edge enhancement value. The image compensation processor compensates the display image data to generate compensated image data according to the image luminance enhancement value, the image color compensating value and the image edge enhancement value.

### CROSS-REFERENCE TO RELATED APPLICATION

This application claims the priority benefit of Taiwan application serial no. 100117045, filed on May 16, 2011. The entirety of the above-mentioned patent application is hereby incorporated by reference herein and made a part of this specification.

### BACKGROUND OF THE INVENTION

1. Field of the Invention

The invention relates to an image compensating method of a display apparatus. Particularly, the invention relates to an image compensating method of a display apparatus performed along with variation of environment luminance.

2. Description of Related Art

In the conventional technique, a method that a display apparatus adjusts a luminance of a display image according to an environment luminance is commonly used. Regarding such conventional method, in a high resolution display apparatus, in order to increase the luminance of the display image, a luminance of a backlight module of the display apparatus has to be increased, or thickness of color filters of the display apparatus is reduced to improve the light transmittance. However, by increasing the luminance of the backlight module of the display apparatus to increase the luminance of the display image, power consumption of the display apparatus is greatly increased. On the other hand, by reducing the thickness of the color filters of the display apparatus to improve the light transmittance, performance of the color filters of the display apparatus is reduced, so that color brightness of the display image generated by the display apparatus is decreased.

On the other hand, according to the conventional technique, in case that the environment luminance is high, the luminance of the backlight module is generally increased to facilitate the user to clearly view the display image. However, when the display image generated by the display apparatus is a high luminance image (for example, a snow ground image), such method lead to a saturation phenomenon of the display image, namely, the whole display frame almost presents a white color, and the user cannot view details of the display image.

In case that the environment luminance is high, the tuning methods are limited to promote the luminance of the image by processing the image data. Furthermore, the whole display frame almost presents a white color by tuning the display image which is a high luminance image (for example, a snow ground image) excessively, and the user cannot view details of the display image.

### SUMMARY OF THE INVENTION

The invention is directed to a display apparatus and an image compensating method thereof, by which a display image is compensated under different environment luminance, so as to maintain the quality of the display image.

The invention provides a display apparatus including an environment luminance detector, a display image data analyser, and an image compensation processor. The environment luminance detector detects an environment luminance and generates an environment luminance grade according to the environment luminance. The display image data analyser receives display image data and analyses a luminance of the display image data to generate a display image data luminance grade. The image compensation processor is coupled to the environment luminance detector and the display image data analyser. The image compensation processor generates an image luminance enhancement value, an image color compensating value and an image edge enhancement value according to the environment luminance grade and the display image data luminance grade. The image compensation processor compensates the display image data to generate compensated image data according to the image luminance enhancement value, the image color compensating value and the image edge enhancement value. The compensated image data is not generated by multiplying the original display image data and an image multiple directly. The luminance of the display image data in an area with higher luminance are reduced by a nonlinear method according to the environment luminance grade. The luminance of the display image data in an area with lower luminance are reduced by a nonlinear method according to the environment luminance grade, too. Such as that, a picture with a tree in a snow ground for example, the snow ground is not saturation after the display image data are compensated (all the picture turn to white color and the detail on the snow ground can not be seen). The luminance of the tree in the snow ground is increased non-linearly, and the tree is outlined on the snow ground.

The invention provides an image compensating method of a display image, which includes following steps. An environment luminance is detected, and an environment luminance grade is generated according to the environment luminance. Display image data of the display image is received to analyse a luminance of the display image data to generate a display image data luminance grade. Then, an image luminance enhancement value, an image color compensating value and an image edge enhancement value are generated according to the environment luminance grade and the display image data luminance grade. The display image data is compensated to generate compensated image data according to the image luminance enhancement value, the image color compensating value and the image edge enhancement value. The reason to compensate the color of the image data is shown as follow. For improving a light through rate of a small size display panel, the small size display panel must use a thick color filter, and the color performance of the display panel is reduced correspondingly. Moreover, increasing the luminance of the display image data regardless linear or non-linear, the color and the detail of the edge are all decreased, that is, the color compensating and the edge enhancement are all necessary.

According to the above descriptions, by detecting the environment luminance of the display apparatus and calculating the display image data luminance grade, the image luminance enhancement value, the image color compensating value and the image edge enhancement value are accordingly calculated according to the environment luminance and the display image data luminance grade. The display apparatus of the invention compensates the display image data by simultaneously adjusting a luminance, a color saturation and an image edge enhancement value of the display image data, so that frames displayed by the display apparatus can be maintained in the same display quality under different environment luminance. The reason to compensate the color of the image data is shown as follow. For improving a light through rate of a small size display panel, the small size display panel must use a thick color filter, and the color performance of the display panel is reduced correspondingly. Moreover, increasing the luminance of the display image data regardless linear or non-linear, the color and the detail of the edge are all decreased, that is, the color compensating and the edge enhancement are all necessary.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display apparatus 100 according to an embodiment of the invention.

FIG. 2 is a relationship curve diagram of luminance and luminance grades according to an embodiment of the invention.

FIG. 3 is a diagram of an environment luminance detector 110 according to an embodiment of the invention.

FIG. 4 is a flowchart illustrating an image compensating method of a display image according to an embodiment of the invention.

### DETAILED DESCRIPTION OF DISCLOSED EMBODIMENTS

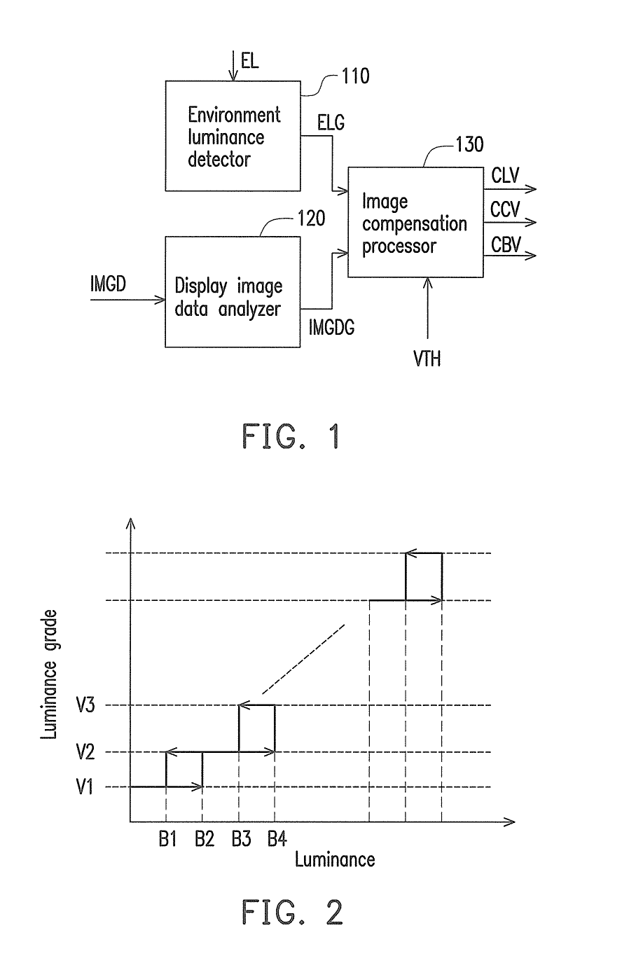

Referring to FIG. 1, FIG. 1 is a schematic diagram of a display apparatus 100 according to an embodiment of the invention. The display apparatus 100 includes an environment luminance detector 110, a display image data analyser 120, and an image compensation processor 130. The environment luminance detector 110 detects an environment luminance EL and generates an environment luminance grade ELG according to the environment luminance EL. The display image data analyser 120 receives display image data IMGD. The display image data analyser 120 analyses gray levels of all of pixel data in the display image data IMGD to determine a luminance of the display image data IMGD. The display image data analyser 120 generates a display image data luminance grade IMGDG according to the luminance of the display image data IMGD.

It should be noticed that the environment luminance detector 110 divides the environment luminance EL into a plurality of grades from a highest possible luminance to a lowest possible luminance. The environment luminance detector 110 obtains the environment luminance grade ELG according to the grade corresponding to the actually detected environment luminance EL. Comparatively, the display image data analyser 120 also divides a possible luminance (gray level) range of the display image data IMGD into a plurality of grades, and determines the grade of the luminance of the display image data IMGD according to gray level distributions of all pixels of the display image data IMGD, so as to generate the display image data luminance grade IMGDG.

Taking the display image data IMGD of 8 bits as an example, the possible luminance range of the display image data IMGD is 0-255, and if it is divided into 16 grades, each grade has 16 different luminance ranges.

The image compensation processor 130 is coupled to the environment luminance detector 110 and the display image data analyser 120. The image compensation processor 130 receives the environment luminance grade ELG and the display image data luminance grade IMGDG respectively generated by the environment luminance detector 110 and the display image data analyser 120, and generates an image luminance enhancement value CLV, an image color compensating value CCV and an image edge enhancement value CBV according to the environment luminance grade ELG and the display image data luminance grade IMGDG.

It should be noticed that when the image compensation processor 130 compensates the display image data IMGD, besides the environment luminance EL is considered, the luminance of the display image data IMGD is also considered. Moreover, the image compensation processor 130 generates the image luminance enhancement value CLV, the image color compensating value CCV and the image edge enhancement value CBV according to the received environment luminance grade ELG and the display image data luminance grade IMGDG. Namely, the image compensation processor 130 simultaneously adjusts the luminance and the color of the display image data IMGD of the display apparatus 100, and adjusts the image edge enhancement value of the display image data IMGD, so as to generate compensated image data.

Namely, besides adjusting a backlight luminance of the display apparatus 100, the image compensation processor 130 further adjusts a color saturation of the display image data IMGD to be displayed by the display apparatus 100. Moreover, the image compensation processor 130 performs a so-called image edge enhancement operation on the display image data IMGD to enhance sharpness of the display image produced by the display apparatus 100.

Moreover, the image compensation processor 130 further receives an image compensation threshold VTH. The image compensation threshold VTH is used to indicate maximum values of the image luminance enhancement value CLV, the image color compensating value CCV and the image edge enhancement value CBV generated by the image compensation processor 130. For example, when the image compensation processor 130 calculates that the display luminance of the display image data IMGD is required to be adjusted, it also calculates whether the display luminance of the adjusted display image data IMGD reaches the maximum value related to a luminance adjustment part in the image compensation threshold VTH. Once the display luminance of the adjusted display image data IMGD reaches the maximum value related to the luminance adjustment part in the image compensation threshold VTH, the display luminance of the display image data IMGD is not further adjusted. Therefore, the display luminance of the display image data IMGD is not excessively adjusted to cause a saturation phenomenon.

Referring to FIG. 2, FIG. 2 is a relationship curve diagram of luminance and luminance grades according to an embodiment of the invention. In the present embodiment, the environment luminance grade and the display image data luminance grade can be respectively generated according to a luminance delay curve 210 corresponding to the environment luminance and the display image data luminance. In FIG. 2, taking the environment luminance as an example, when the environment luminance is increased from a luminance B1 to a luminance B2, the environment luminance grade is increased from a luminance grade V1 to a luminance grade V2. When the environment luminance is increased from a luminance B2 to a luminance B3, the environment luminance grade is maintained to the luminance grade V2, and until the environment luminance is continually increased to a luminance B4, the environment luminance grade is increased to a luminance grade V3.

On the other hand, when the environment luminance is equal to the luminance B2 and now the environment luminance grade is equal to the luminance grade V2, if the environment luminance is decreased to a value between the luminance B2 and the luminance B1, the environment luminance grade is not immediately changed, but is maintained to the luminance grade V2, and such phenomenon is referred to as a delay phenomenon. The above delay phenomenon avails the display apparatus of the embodiment reducing sensitivity for the fast changing environment light and effectively increasing stability of the display apparatus.

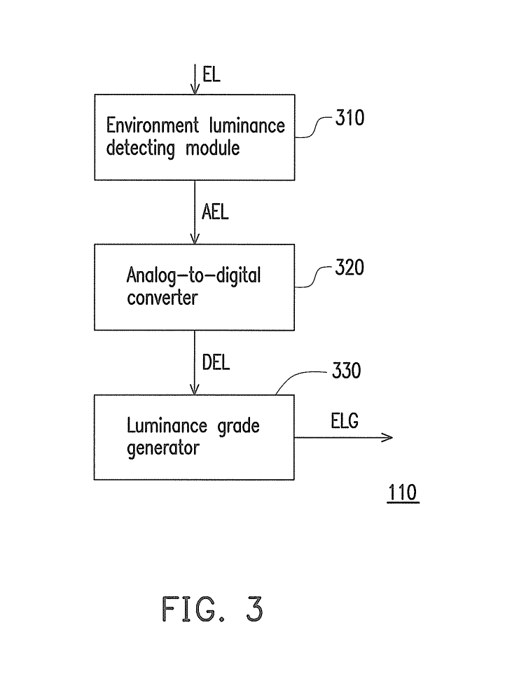

Referring to FIG. 3, FIG. 3 is a diagram illustrating an implementation of the environment luminance detector 110 according to an embodiment of the invention. The environment luminance detector 110 includes an environment luminance detecting module 310, an analog-to-digital converter 320 and a luminance grade generator 330. The environment luminance detecting module 310 detects a luminance value of the environment luminance EL. The analog-to-digital converter 320 is coupled to the environment luminance detecting module 310 for receiving an analog format environment luminance AEL generated by the environment luminance detecting module 310. The analog-to-digital converter 320 converts the analog format environment luminance AEL to a digital format to generate a digital format environment luminance DEL. The luminance grade generator 330 is coupled to the analog-to-digital converter 320. The luminance grade generator 330 receives the digital format environment luminance DEL, and generates the environment luminance grade ELG with reference of the luminance delay curve shown in FIG. 2 according to the digital format environment luminance DEL.

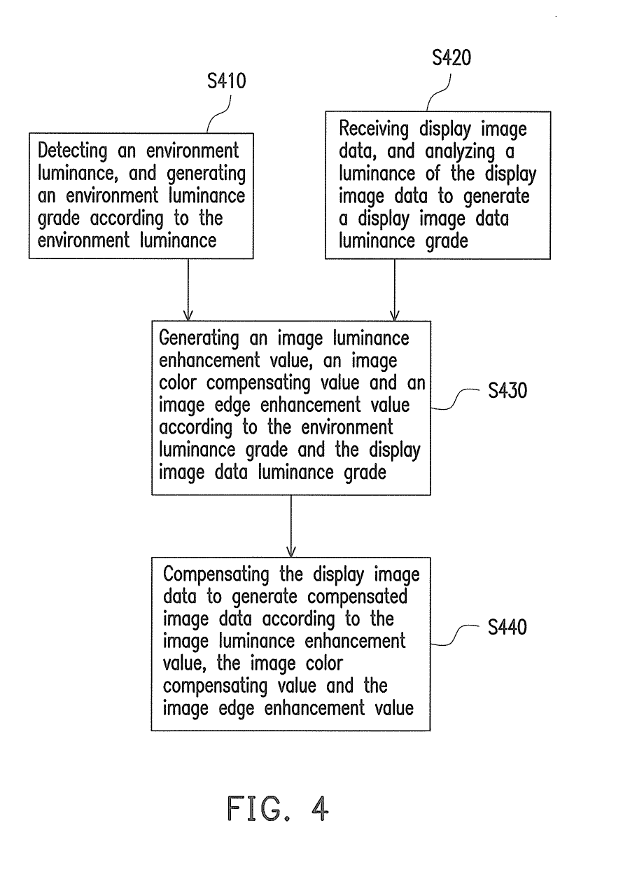

Referring to FIG. 4, FIG. 4 is a flowchart illustrating an image compensating method of a display image according to an embodiment of the invention. The image compensating method includes following steps. An environment luminance is detected, and an environment luminance grade is generated according to the environment luminance (S410). Moreover, display image data of the display image to be displayed by the display apparatus is received, and a luminance of the display image data is analyzed for generating a display image data luminance grade (S420). Then, an image luminance enhancement value, an image color compensating value and an image edge enhancement value are generated according to the environment luminance grade and the display image data luminance grade (S430). Finally, the display image data is compensated to generate compensated image data according to the image luminance enhancement value, the image color compensating value and the image edge enhancement value (S440).

It should be noticed that an executing sequence of the steps S410 and S420 is not specified. Moreover, detection of the environment luminance and analysis of the luminance of the display image data can be dynamically performed.

Implementation details of the image compensating method have been described in detail in the aforementioned embodiment, so that descriptions thereof are not repeated.

In summary, by detecting the environment luminance grade, and analysing the display image data luminance grade, image compensation is performed with consideration of both of the environment luminance and the display image data luminance. Moreover, besides adjusting the luminance of the display image data, the display image data is compensated by simultaneously adjusting the color saturation and the image edge enhancement value of the display image data, so that the display image of the display apparatus can be maintained to an optimal display quality under different environment luminance.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display apparatus, comprising:
an environment luminance detector, detecting an environment luminance and generating an environment luminance grade according to the environment luminance;
a display image data analyser, receiving display image data and analysing a luminance of the display image data to generate a display image data luminance grade; and
an image compensation processor, coupled to the environment luminance detector and the display image data analyser, and generating an image luminance enhancement value, an image color compensating value and an image edge enhancement value according to the environment luminance grade and the display image data luminance grade, and compensating the display image data to generate compensated image data according to the image luminance enhancement value, the image color compensating value and the image edge enhancement value.

2. The display apparatus as claimed in claim 1, wherein the environment luminance detector comprises:
an environment luminance detecting module, detecting the environment luminance;
an analog-to-digital converter, coupled to the environment luminance detecting module for converting the environment luminance of an analog format into a digital format; and
a luminance grade generator, coupled to the analog-to-digital converter, receiving the environment luminance of the digital format, and generating the environment luminance grade according to the environment luminance.

3. The display apparatus as claimed in claim 2, wherein the luminance grade generator generates the environment luminance grade with reference of a luminance delay curve according to the environment luminance.

4. The display apparatus as claimed in claim 1, wherein the display image data analyser generates the display image data luminance grade with reference of a luminance delay curve according to the luminance of the display image data.

5. The display apparatus as claimed in claim 1, wherein the image compensation processor further receives an image compensation threshold for indicating maximum values of the image luminance enhancement value, the image color compensating value and the image edge enhancement value.

6. An image compensating method of a display image, comprising:
detecting an environment luminance, and generating an environment luminance grade according to the environment luminance;
receiving display image data of the display image, and analyzing a luminance of the display image data to generate a display image data luminance grade;
generating an image luminance enhancement value, an image color compensating value and an image edge enhancement value according to the environment luminance grade and the display image data luminance grade; and
compensating the display image data to generate compensated image data according to the image luminance enhancement value, the image color compensating value and the image edge enhancement value.

7. The image compensating method of the display image as claimed in claim 6, wherein the step of generating the environment luminance grade according to the environment luminance comprises:
generating the environment luminance grade with reference of a luminance delay curve according to the environment luminance.

8. The image compensating method of the display image as claimed in claim 6, wherein the step of generating the display image data luminance grade according to the luminance of the display image data comprises:
generating the display image data luminance grade with reference of a luminance delay curve according to the luminance of the display image data.

9. The image compensating method of the display image as claimed in claim 6, wherein the step of generating the image luminance enhancement value, the image color compensating value and the image edge enhancement value according to the environment luminance grade and the display image data luminance grade comprises:
receiving an image compensation threshold for indicating maximum values of the image luminance enhancement value, the image color compensating value and the image edge enhancement value.
